(19) United States
(12) Patent Application Publication
(10) Pub. No.: US 2024/0257085 A1
(43) Pub. Date: Aug. 1, 2024

(54) Token Account Payment Computing System

(71) Applicant: Bank of America Corporation, Charlotte, NC (US)

(72) Inventors: Jesika Gandhi, Sunnyvale, CA (US); Jeetendra Hukmichand Jain, Charlotte, NC (US)

(73) Assignee: Bank of America Corporation, Charlotte, NC (US)

(21) Appl. No.: 18/161,667

(22) Filed: Jan. 30, 2023

(51) Int. Cl. G06Q 20/10; G06Q 20/34

(52) U.S. Cl. CPC G06Q 20/108; G06Q 20/351

(57) ABSTRACT

Various aspects of the disclosure relate to creation, management, and use of electronic payment tokens to facilitate coordination of payments for products and/or services. A payment token account system may facilitate creation of a payment token account and an associated payment token to electronically receive deposit from one or more sources and to complete an electronic payment transaction. Each payment token may be separately enabled and disabled and may be associated as a backup to another payment account to ensure a payment transaction may be completed when a payment network associated with the payment account is down or otherwise unavailable.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization. These computing systems may include payment computing systems configured to perform payment transactions in multiple environments, such as retail environments, restaurants, and the like. Existing payment systems may often be limited in its ability to associate multiple payment accounts to a single transaction, so that these multi-payment account based transactions must be completed via multiple separate transactions leading to an increase in traffic on the payment computing system network and/or loss of an electronic transaction during the conversion process. As such as need has been recognized for an improved payment transaction system.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes associating a configurable payment token account to a primary payment account, where funds may be deposited from multiple sources, where an associated user may enable the payment token account, disable the payment token account, or configure the payment token account as a backup to the primary account (e.g., the payment token account and/or the payment token may be a secondary account to the primary account, such as a credit card account, or the like). In some cases, the payment token account and/or the payment token may be used as a primary account from which a transaction is completed, for example, an electronic payment transaction for a product or service may be completed from the payment token account and/or the payment token.

Aspects of the disclosure relate to computer hardware and software. In particular, one or more aspects of the disclosure generally relate to computer hardware and software facilitating electronic payment transactions via a configurable token account.

As discussed above, a user (e.g., a banking customer of a financial institution) may create an electronic funding account (e.g., a token account) that may be associated with a token (e.g., a virtual card number) with the token requestor. In some cases, the token requestor may be a retailer, a restaurant, a vendor, and/or the like. The token account may be configured to receive funds via an associated alias (e.g., a phone number, a credit card, funds deposit via an automated teller machine (ATM), and the like). The associated customer, or other parties, may deposit funds into the token account via the associated alias. A user interface may be available to the user to facilitate configuration of the token account, such as associating a primary account (e.g., a credit card account, a debit account, or the like) and/or giving an ability to enable the token account (e.g., “turn on), disable the token account (e.g., “turn off”), configure the token account for backup use only (e.g., use of the token account when the associated primary account is unavailable). or backup only the use of token account. Once configured, the token account may only allow funds to be debited when the token account is enabled. In some cases, such as when the token account is configured as a backup to the primary account, the token account may be debited when a payment network is unavailable (e.g., when an issuing bank network associated with the primary account, such as a credit card, is not reachable). Additionally, a reporting engine may notify the use when a status of the token account has changed and/or an action has occurred, such as enabling the account, disabling the account, depositing funds into the account, withdrawing funds from the account, and/or the like.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for creation and management of payment token accounts, in accordance with one or more aspects described herein;

FIG. 1B shows an illustrative computing platform enabled for creation and management of payment token accounts, in accordance with one or more aspects described herein;

FIG. 2 shows an illustrative process for creation and management of payment token accounts, with one or more aspects described herein; and

FIG. 3 shows an illustrative computing system incorporating a payment token account computing system in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

Various aspects of the disclosure relate to creation, management, and use of electronic payment tokens to facilitate coordination of payments for products and/or services. A payment token account system may facilitate creation of a payment token account and an associated payment token to electronically receive deposit from one or more sources and to complete an electronic payment transaction. Each payment token may be separately enabled and disabled and may be associated as a backup to another payment account to ensure a payment transaction may be completed when a payment network associated with the payment account is down or otherwise unavailable. Illustrative payment token functionality supported by a payment token account computing system may include generating, based on a user request, a payment token, configuring, based on user input received from a user device, the payment token, wherein a payment token configuration defines use cases for the payment token, receiving, via a network and from a deposit computing system, an electronic funds deposit request, accepting, based on the configuration, the electronic funds deposit, receiving, via a network and from the payment computing system, a payment request associated with the electronic payment transaction, initiating payment, via the payment token, to a deposit account associated with the electronic payment transaction, based on the payment token configuration, and sending, via the network and to the payment computing system, confirmation of completion of the electronic payment transaction. In some cases, the payment token account computing system may issue an error or disable a payment token in response to invalid activity requests based on the configuration, insufficient funds, use before deposits have been made, and/or the like.

As discussed above, a user may create an electronic token account that may be associated with a token (e.g., a virtual card number) with the token requestor. In some cases, the token requestor may be a retailer, a restaurant, a vendor, and/or the like. The token account may be configured to receive funds via an associated alias (e.g., a phone number, a credit card, funds deposit via an automated teller machine (ATM), and the like). The associated customer, or other parties, may deposit funds into the token account via the associated alias. A user interface may be available to the user to facilitate configuration of the token account, such as associating a primary account (e.g., a credit card account, a debit account, or the like) and/or giving an ability to enable the token account (e.g., “turn on), disable the token account (e.g., “turn off”), configure the token account for backup use only (e.g., use of the token account when the associated primary account is unavailable), or backup only the use of token account. Once configured, the token account may only allow funds to be debited when the token account is enabled. In some cases, such as when the token account is configured as a backup to the primary account, the token account may be debited when a payment network is unavailable (e.g., when an issuing bank network associated with the primary account, such as a credit card, is not reachable). Additionally, a reporting engine may notify the use when a status of the token account has changed and/or an action has occurred, such as enabling the account, disabling the account, depositing funds into the account, withdrawing funds from the account, and/or the like. In some cases, the token account may be incorporated with a distributed ledger (e.g., a blockchain computing system) to provide additional security and immutability, such as to provide traceability of use of the payment token account (e.g., depositing of funds, payments made, configuration changes, and the like).

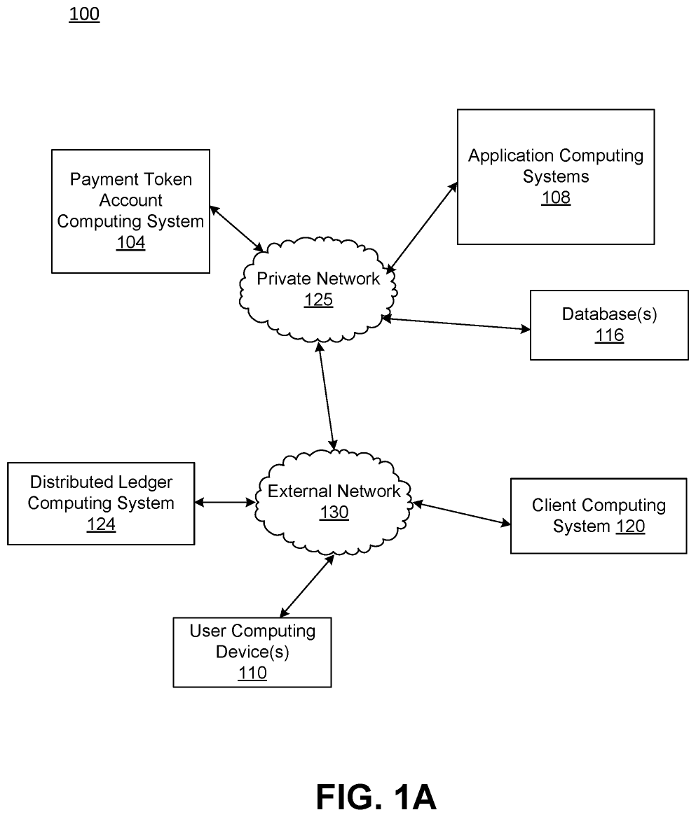

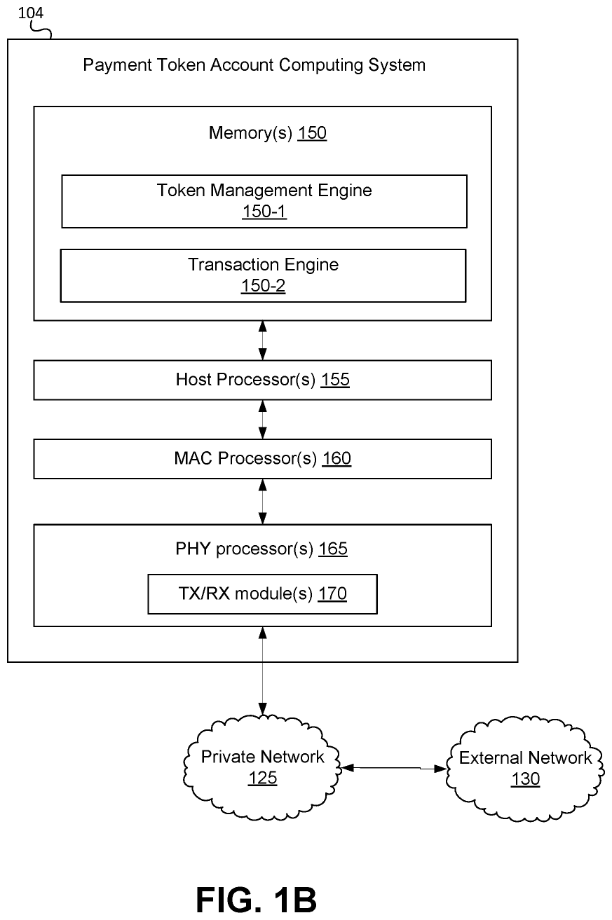

FIG. 1A shows an illustrative computing environment 100 for creation, use, and management of payment token accounts, in accordance with one or more arrangements. The computing environment 100 may comprise one or more devices (e.g., computer systems, communication devices, and the like). The computing environment 100 may comprise, for example, a payment token account computing system 104, one or more application computing system 108, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing system 120, a distributed ledger computing system 124, and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3rd Generation Partnership Project (3GPP) cellular protocol, a hypertext transfer protocol (HTTP), etc.). While FIG. 1A shows the payment token account computing system 104 as being a separate computing system, aspects of the payment token account computing system 104 may be incorporated within one or more different computing systems, such as one or more of the application computing systems 108.

The payment token account computing system 104 may comprise one or more computing devices and/or other computer components (e.g., processors, memories, communication interfaces) configured to perform one or more functions as described herein, such as and creation of a payment token account, management and/or configuration of the payment token account, and use of the payment token account. Further details associated with the architecture of the payment token account computing system 104 are described with reference to FIG. 1B.

The application computing systems 108 and/or the client computing system 120 may comprise one or more computing devices and/or other computer components (e.g., processors, memories, communication interfaces). In addition, application computing systems 108 and/or the client computing system 120 may be configured to host, execute, and/or otherwise provide one or more enterprise applications. In some cases, the application computing systems may host one or more services configured facilitate operations requested through one or more API calls, such as data retrieval and/or initiating processing of specified functionality. In some cases, the client computing system 120 may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The client computing system 122 and/or the application systems 108 may comprise various servers and/or databases that store and/or otherwise maintain account information, such as financial account information including account balances, transaction history, account owner information, and/or other information. In addition, application computing systems 108 and/or the client computing system 120 may process and/or otherwise execute transactions on specific accounts based on commands and/or other information received from other computer systems comprising the computing environment 100. In some cases, one or more of the application computing systems 108 and/or the client computing system 120 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125, as authenticated by an authentication computing system. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing system 120 may comprise one or more computing devices and/or other computer components (e.g., processors, memories, communication interfaces). The client computing system 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing system 120 is for processing an electronic exchange of goods and/or services. The client computing system 120 may be associated with a specific goods purchasing activity, such as purchasing a vehicle, transferring title of real estate, providing payment for a service rendered and may communicate with one or more other platforms within the client computing system 120. In some cases, the client computing system 120 may integrate API calls to request data, initiate functionality, or otherwise communicate with the one or more application computing systems 108, such as via the services. For example, the services may be configured to facilitate data communications (e.g., data gathering functions, data writing functions, and the like) between the client computing system 120 and the one or more application computing systems 108.

The user device(s) 110 may be computing devices (e.g., desktop computers, laptop computers) or mobile computing device (e.g., smartphones, tablets) connected to the network 125 and/or the network 130. The user device(s) 110 may be configured to enable the user to access the various functionalities provided by the devices, applications, and/or systems in the network 125, such as via the external network 130.

The distributed ledger computing system 124 may be (and/or may include multiple components of) a decentralized peer-to-peer (e.g., P2P) system specialized for the purpose of managing and/or participating as part of a blockchain, or other distributed networks. The decentralized P2P system may be comprised of computing devices that are distributed in multiple locations across a geographical area as opposed to a single location such as a business or company. The computing devices forming the decentralized P2P system may operate with each other to manage a blockchain, which may be a data structure used to store information related to the decentralized P2P system. More specifically, the blockchain may be a chronological linkage of data elements (e.g., blocks) which store data records relating to the decentralized computing system.

A user may access the decentralized P2P system through a specialized “wallet” that serves to uniquely identify the user and enable the user to perform functions related to the decentralized P2P network. Through the wallet, the user may be able to hold tokens, funds, or any other asset associated with the decentralized P2P system. Furthermore, the user may be able to use the wallet to request performance of network-specific functions related to the decentralized P2P system such as fund, token, asset transfers and/or user authentication. The various computing devices forming the decentralized P2P computing system may operate as a team to perform network-specific functions requested by the user. In performing the network-specific functions, the various computing devices may produce blocks that store the data generated during the performance of the network-specific functions and may add the blocks to the blockchain. After the block has been added to the blockchain, the wallet associated with the user may indicate that the requested network-specific function has been performed.

In more detail, the decentralized P2P system may be specialized for the purpose of managing a distributed ledger, such as a private blockchain or a public blockchain, through the implementation of digital cryptographic hash functions, consensus algorithms, digital signature information, and network-specific protocols and commands. The decentralized P2P system (e.g., decentralized system) may be comprised of decentralized system infrastructure consisting of a plurality of computing devices, either of a heterogeneous or homogenous type, which serve as network nodes (e.g., full nodes and/or lightweight nodes) to create and sustain a decentralized P2P network (e.g., decentralized network). Each of the full network nodes may have a complete replica or copy of a blockchain stored in memory and may operate in concert, based on the digital cryptographic hash functions, consensus algorithms, digital signature information, and network-specific protocols, to execute network functions and/or maintain inter-nodal agreement as to the state of the blockchain. Each of the lightweight network nodes may have at least a partial replica or copy of the blockchain stored in memory and may request performance of network functions through the usage of digital signature information, hash functions, and network commands. In executing network functions of the decentralized network, such as balance sheet transactions and smart contract operations, at least a portion of the full nodes forming the decentralized network may execute the one or more cryptographic hash functions, consensus algorithms, and network-specific protocols to register a requested network function on the blockchain. In some instances, a plurality of network function requests may be broadcasted across at least a portion of the full nodes of the decentralized network, aggregated through execution of the one or more digital cryptographic hash functions, and validated by performance of the one or more consensus algorithms to generate a single work unit (e.g., block), which may be added in a time-based, chronological manner to the blockchain through performance of network-specific protocols.

While in practice the term “blockchain” may hold a variety of contextually derived meanings, the term blockchain, as used herein, refers to a concatenation of sequentially dependent data elements (e.g., blocks) acting as a data ledger that stores records relating to a decentralized computing system. Such data records may be related to those used by a particular entity or enterprise, such as a financial institution, and/or may be associated with a particular application and/or use case including, but not limited to, cryptocurrency, digital content storage and delivery, entity authentication and authorization, digital identity, marketplace creation and operation, internet of things (e.g., IoT), prediction platforms, consensus gathering activities, wellness records, currency exchange and remittance, P2P transfers, ride sharing, entertainment applications, trading platforms, and real estate, precious metal, and work of art registration and transference, among others. A “private blockchain” may refer to a blockchain of a decentralized private system in which only authorized computing devices are permitted to act as nodes in a decentralized private network and have access to the private blockchain. In some instances, the private blockchain may be viewable and/or accessible by authorized computing devices which are not participating as nodes within the decentralized private network, but still have proper credentials. A “public blockchain” may refer to a blockchain of a decentralized public system in which any computing devices may be permitted to act as nodes in a decentralized public network and have access to the public blockchain. In some instances, the public blockchain may be viewable and/or accessible by computing devices which are not participating as nodes within the decentralized public network.

Further, a “full node” or “full node computing device,” as used herein, may describe a computing device in a decentralized system which operates to create and maintain a decentralized network, execute requested network functions, and maintain inter-nodal agreement as to the state of the blockchain. In order to perform such responsibilities, a computing device operating as a full node in the decentralized system may have a complete replica or copy of the blockchain stored in memory, as well as executable instructions for the execution of hash functions, consensus algorithms, digital signature information, network protocols, and network commands. A “lightweight node,” “light node,” “lightweight node computing device,” or “light node computing device” may refer to a computing device in a decentralized system, which operates to request performance of network functions (e.g., balance sheet transactions, smart contract operations, and the like) within a decentralized network but without the capacity to execute requested network functions and maintain inter-nodal agreement as to the state of the blockchain. As such, a computing device operating as a lightweight node in the decentralized system may have a partial replica or copy of the blockchain. In some instances, network functions requested by lightweight nodes to be performed by the decentralized network may also be able to be requested by full nodes in the decentralized system.

“Network functions” and/or “network-specific functions,” as described herein, may relate to functions which are able to be performed by nodes of a decentralized P2P network. In some arrangements, the data generated in performing network-specific functions may or may not be stored on a blockchain associated with the decentralized P2P network. Examples of network functions may include “smart contract operations,” “balance sheet transactions,” and/or user data authentication. A smart contract operation, as used herein, may describe one or more operations performed by a “smart contract,” which may be one or more algorithms and/or programs associated with one or more nodes within a decentralized P2P network. A balance sheet transaction may describe one or more changes to data holdings associated with one or more nodes within a decentralized network.

In one or more aspects of the disclosure, a “digital cryptographic hash function,” as used herein, may refer to any function which takes an input string of characters (e.g., message), either of a fixed length or non-fixed length, and returns an output string of characters (e.g., hash, hash value, message digest, digital fingerprint, digest, and/or checksum) of a fixed length. Examples of digital cryptographic hash functions may include BLAKE (e.g., BLAKE-256, BLAKE-512, and the like), MD (e.g., MD2, MD4, MD5, and the like), Scrypt, SHA (e.g., SHA-1, SHA-256, SHA-512, and the like), Skein, Spectral Hash, SWIFT, Tiger, and so on. A “consensus algorithm,” as used herein and as described in further detail below, may refer to one or more algorithms for achieving agreement on one or more data values among nodes in a decentralized network. Examples of consensus algorithms may include proof of work (e.g., PoW), proof of stake (e.g., PoS), delegated proof of stake (e.g., DPOS), practical byzantine fault tolerance algorithm (e.g., PBFT), and so on. Furthermore, “digital signature information” may refer to one or more private/public key pairs and digital signature algorithms which are used to digitally sign a message and/or network function request for the purposes of identity and/or authenticity verification. Examples of digital signature algorithms which use private/public key pairs contemplated herein may include public key infrastructure (PKI), Rivest-Shamir-Adleman signature schemes (e.g., RSA), digital signature algorithm (e.g., DSA), Edwards-curve digital signature algorithm, and the like. A “wallet,” as used herein, may refer to one or more data and/or software elements (e.g., digital cryptographic hash functions, digital signature information, and network-specific commands) that allow a node in a decentralized P2P network to interact with the decentralized P2P network.

A decentralized P2P system implementing a blockchain data structure may provide solutions to technological problems existing in current centralized system constructs with traditional data storage arrangements. For example, data storage arrangements that use a central data authority have a single point of failure (namely, the central storage location) which, if compromised by a malicious attacker, can lead to data tampering, unauthorized data disclosure, and unauthorized use and/or loss of operative control of the processes performed by the centralized system. The implementation of a blockchain data structure in a decentralized P2P system acts as a safeguard against unreliable and/or malicious nodes acting in the decentralized P2P network to undermine the work efforts of the other nodes, e.g., by providing byzantine fault tolerance within the network.

The database(s) 116 may comprise one or more computer-readable memories storing information that may be used by payment token account computing system 104. For example, the database(s) 116 may store token account associations, token account configurations, metrics associated with token account use and/or functionality, and the like. In an arrangement, the database(s) 116 may be used for other purposes as described herein. In some cases, the client computing system 120 may write data or read data to the database(s) 116 via the services.

In one or more arrangements, the payment token account computing system 104, the application computing systems 108, the databases 116, the client computing system 120, the distributed ledger computing system 124, the client computing system 120, the user devices 110, and/or the other devices/systems in the computing environment 100 may be any type of computing device capable of receiving input via a user interface, and communicating the received input to one or more other computing devices in the computing environment 100. For example, the payment token account computing system 104, the application computing systems 108, the databases 116, the client computing system 120, the distributed ledger computing system 124, the client computing system 120, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the payment token account computing system 104, the application computing systems 108, the databases 116, the client computing system 120, the distributed ledger computing system 124, the client computing system 120, the user devices 110, and/or the other devices/systems in the computing environment 100 may, in some instances, be and/or comprise special-purpose computing devices configured to perform specific functions.

FIG. 1B shows an illustrative payment token account computing system 104 in accordance with one or more examples described herein. The payment token account computing system 104 may be a stand-alone device and/or may at least be partial integrated with the development computing system 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The payment token account computing system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the payment token account computing system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 130. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the payment token account computing system 104 may be configured to execute machine readable instructions stored in memory 150. The memory 150 may comprise (i) one or more program modules/engines having instructions that when executed by the one or more processors cause the payment token account computing system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the payment token account computing system 104 and/or by different computing devices that may form and/or otherwise make up the payment token account computing system 104. For example, the memory 150 may have, store, and/or comprise a token management engine 150-1, a transaction engine 150-2, and/or the like. The token management engine 150-1 may have instructions that direct and/or cause the payment token account computing system 104 to perform one or more operations associated with creation, configuration, and enablement of payment token accounts. The transaction engine 150-2 may have instructions that may cause the payment token account computing system 104 to complete a deposit transaction, to complete a payment transaction, and/or the like.

While FIG. 1A illustrates the payment token account computing system 104 and the application computing systems 108, as being separate elements connected in the private network 125, in one or more other arrangements, functions of one or more of the above may be integrated in a single device/network of devices. For example, elements in payment token account computing system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application computing systems 108.

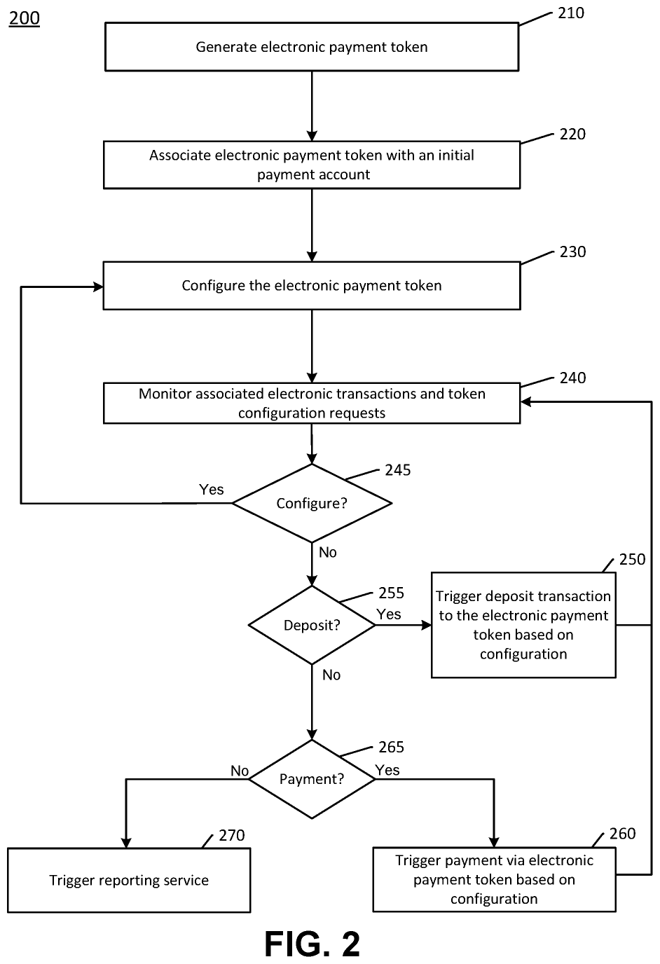

FIG. 2 shows an illustrative process 200 for creation and management of payment token accounts, with one or more aspects described herein. For example, the payment token account computing system 104 may be triggered to create a payment token account for a particular user based on a triggering input, such as one received via a user interface screen presented at a user device, at 210. The user input causes the payment token account computing system 104 to generate a payment token account and one or more payment tokens associated with that account. In some cases, the payment token account computing system 104 may associate the payment token account and/or one or more of the payment tokens to a distributed ledger computing system, such as by generating one or more blocks in a blockchain. For example, the payment token account may be associated with a first block in a block chain and each payment token associated with the account may be associated with a different additional block added to the blockchain. In some cases, transactions associated with a payment token may be added as a block to the main blockchain or may be added as part of a sub-chain off the main blockchain.

When the payment token account computing system 104 creates a payment token account, the payment token account may be associated with one or more electronic transaction computing systems of an enterprise organization (e.g., a financial institution, a banking institution, and/or the like). For example, the payment token account may be generated to interact with a deposit transaction computing system and a payment transaction computing system of the enterprise organization. In some cases, the payment token account may be associated with an account management computing system and/or one or more accounts associated with the user requesting creation of the payment token account. For example, the account management computing systems may associate one or more electronic accounts associated with the user (e.g., a savings account, a checking account, and the like) to facilitate funds transfer functionalities and/or to leverage existing authentication and/or user verification functionalities.

At 220, the payment token account computing system 104 may associate a created payment token to one or more payment accounts. For example, the payment token may be associated with a newly created payment account (e.g., a one-time account, a multi-use account) that may be used to facilitate funds transfer transactions associated with payments from the payment token account to a deposit account associated with the vendor. In some cases, the payment token may be associated with an existing or newly created electronic wallet. In some cases, the payment token account may be associated with an existing payment method (e.g., a debit card, a credit card) to be used as a failsafe backup to complete payments when a financial transaction network (e.g., a banking computing system, a credit card processing computing system, and/or the like) is unavailable or otherwise inactive. As such, the payment token may be used to complete a transaction when a portion of credit card processing network is unavailable so that the payment transaction would otherwise fail.

At 230, the payment token account computing system 104 may cause a user interface to be presented at a user screen of a user device to allow the user to configure the payment token account and/or one or more payment tokens associated with the account. For example, the user interface may solicit user input to configure each payment token associated with the payment token account. For example, the user may enable use of the payment token, disable use of the payment token and/or limit use of the payment token to provide the failsafe payment functionality for the associated payment account. In some cases, the payment token account computing system 104 may configure the payment toke as a single use token or a multi-use token, where the single use token may be used for a single or otherwise specified transaction (e.g., a purchase) and the multi-use token may be reused in multiple payment transactions.

At 240, the payment token account computing system 104 may monitor communications associated with each payment token account to identify a configuration request, a payment request, a deposit request, a reporting request. In some cases, the payment token account computing system 104 may monitor communications associated with each payment token account to identify a creation request for a new token, such as a creation of a new single use payment token. If, at 245, a configuration request was identified, the payment token account computing system 104 may identify the payment token account and/or the payment token associated with the configuration request and may present a configuration user interface screen to the user to solicit new configuration information and the payment token account computing system 104 to configure the payment token account and/or payment tokens at 230. If, at 245, the request was not a configuration request, the payment token account computing system 104 may determine whether the communication is a request deposit funds to the account. In some cases, one or more application computing systems 108 (e.g., deposit computing system of the enterprise organization) may automatically trigger completion, at 250, of a deposit to the payment token account (e.g., a funds transfer transaction from a savings or checking account, a credit transaction from an unassociated credit or debit card account, a funds transfer transaction via a funds transfer application, a cash deposit transaction via an ATM, and/or the like). In some cases, such as depending on configuration setting of the payment token account, a communication may be sent to the user device with information corresponding to the deposit transaction and/or to approve completion of the deposit. Once the deposit action has been triggered, the payment token account computing system 104 may proceed to monitor transactions and/or configuration requests at 240.

If, at 265, a payment request is identified, the payment token account computing system 104 may initiate a payment transaction at 260 based on the configuration settings. For example, the payment token account computing system 104 may trigger payment, via a payment computing system of the payment of the application computing systems 108, payment request by a requested payment token based on an associated payment method (e.g., a virtual payment card number, an electronic person to person transfer, a deposit to another payment token account, and/or the like). Once the payment action has been triggered, the payment token account computing system 104 may proceed to monitor transactions and/or configuration requests at 240. If the request is not a configuration request, a deposit request, or a payment request, the payment token account computing system 104 may initiate a reporting action at 270. For example, the request may be a request received from the user device 110 for display of current information associated with a payment token account and/or one or more payment tokens. For example, the payment token account computing system 104 may cause display of a reporting screen at the user interface of the user device. In case of an unknown request, the payment token account computing system 104 may initiate an error reaction to determine a cause of the unknown input and/or failure to identify a configuration, deposit or payment request. In some cases, the payment token account computing system 104 may initiate an alert, or improper activity mitigation processes, based on an identification of an attempt at unauthorized use of the payment token and/or access to the payment token account.

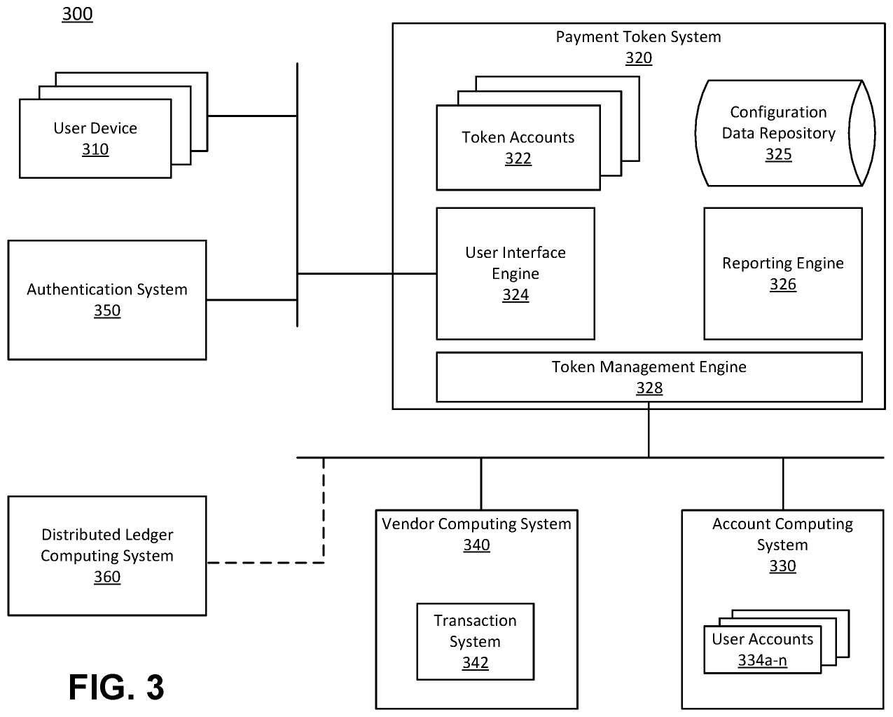

FIG. 3 shows an illustrative computing system 300 incorporating a payment token account computing system in accordance with one or more aspects described herein. The illustrative computing system may include one or more user devices 310 (e.g., user devices 110), an authentication system 350, a payment token system 320, an account computing system 330, a vendor computing system 340, and/or, optionally, a distributed ledger computing system 360. The payment token system 320 may include one or more token accounts 322 (each including one or more payment tokens), a configuration data repository 325, a user interface engine 324, a reporting engine 326, and/or a token management engine 328.

As discussed above, users may access, configure, deposit funds, and/or initiate payments using a payment token account and/or a payment token via one or more user devices 310. In some cases, the payment token account may be configurable and/or accessed via an application or other program operational on the user device and may be interacted with via one or more user interface devices (e.g., a user interface screen, a user input device such as a touch screen, a keyboard, a mouse, and the like). In some cases, the payment token functionality may be incorporated within a banking application or other financial services application. In some cases, a payment interface integrated into a website may facilitate configuration, setup, creation and/or use of a payment token via an interactive user interface screen. In some cases, the authentication system 350 may be leveraged to perform authentication of a user of a payment token, whether the user associated with a payment token account, a depositor of funds to a payment token, and/or a vendor seeking payment from the payment token.

As mentioned, each token account 322 may include one or more payment tokens. Each token account may be associated with a user, or group of users. In some cases, the payment token accounts 322 may be created as a one-time use token account, such as to facilitate payment of a common purchase (e.g., an activity) to be paid for by funds pooled from multiple individuals and/or accounts. In some cases, an individual token account associated to a single user may be configured to solicit and receive funds from multiple sources. Configurations associated with each of the token accounts 322 may be stored in the configuration data repository 325 and may include an enablement flag (enabled/disabled), a use flag (single use, multi-use), an expiration date defining a time period during which the payment token is enabled, disabled and/or valid, a creation date, owner information, depositor information, allowed user information, allowed use information (e.g., purchases only, account backup only, and the like), a list of allowable users, a list of allowable depositors, and the like.

The user interface engine may coordinate user interactions with one or more payment token accounts and/or payment tokens including, for example, configuration and/or authentication activities. The reporting engine 326 may manage communication of payment token account status periodically and/or in an on-demand basis. The reporting engine 326 may also coordinate error reporting, troubleshooting, and/or identification and mitigation of malicious activities.

The account computing system 330 may include one or more different computing systems of the application computing systems 108 of one or more financial institutions. For example, the user accounts 334a-n may be a banking account (e.g. a checking account, a savings account), a brokerage account, a credit card account computing system, a debit card account, and/or other account associated with online activities that require payment. The account computing system's functionalities may be leveraged to facilitate deposits to and/or seek payments from the token accounts 322. The vendor computing system 340 may include a transaction computing system 342 used to initiate an electronic transaction seeking payment for a product or service and from one or more token accounts 322. The distributed ledger computing system 360 optionally may be used to provide traceability, immutability, and protection from improper use through the processes discussed above, such as by associating a blockchain (e.g., an initial block of a blockchain or a sub-chain of a blockchain) with a payment token account and/or a payment token, with subsequently added blocks being associated with configuration activities, deposit activities, payment activities, reporting activities (e.g., report generation, view requests, and the like), improper activity identifications, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a payment computing system initiating an electronic payment transaction;
a payment token account platform, comprising:
at least one processor; and
non-transitory memory storing computer-readable instructions that, when executed by the at least one processor, cause the payment token account platform to:
generate, based on a user request, a payment token;
configure, based on user input received from a user device, the payment token, wherein a payment token configuration defines use cases for the payment token;
receive, via a network and from a deposit computing system, an electronic funds deposit request;
accept, based on the configuration, the electronic funds deposit;
receive, via a network and from the payment computing system, a payment request associated with the electronic payment transaction;
initiate payment, via the payment token, to a deposit account associated with the electronic payment transaction, based on a payment token configuration; and
send, via the network and to the payment computing system, confirmation of completion of the electronic payment transaction.

2. The system of claim 1, wherein the instructions further cause the payment token account platform to:
present, at a user device, a payment token configuration screen; and
solicit, via the payment token configuration screen, a configuration of the payment token.

3. The system of claim 1, wherein the instructions further cause the payment token account platform to associate a virtual card number to the payment token.

4. The system of claim 3, wherein the instructions further cause the payment token account platform to:
identify, based on the virtual card number, from the electronic payment transaction.

5. The system of claim 1, wherein the instructions further cause the payment token account platform to:
associate a group of users with permissions to deposit funds to the token account; and
solicit, via messages sent via the network to each user of the group of users, deposit of funds via one or more electronic transactions.

6. The system of claim 1, wherein the instructions further cause the payment token account platform to associate a second group of users with permissions to initiate a payment transaction using the token account.

7. The system of claim 1, wherein the payment token configuration comprises one or both of an enablement flag and an association with a payment account.

8. The system of claim 7, wherein the payment account is a credit card, where configuration specifies that the payment token is used for payments when a credit card network is unavailable.

9. The system of claim 1, wherein the payment token is associated with a payment token account.

10. The system of claim 1, wherein the payment token is associated with a payment token account and wherein the payment token account is associated with a plurality of payment tokens, each payment token of the plurality of payment tokens having a different configuration.

11. A method comprising:
generating, based on a user request, a payment token;
configuring, based on user input received from a user device, the payment token, wherein a payment token configuration defines use cases for the payment token;
receiving, via a network and from a deposit computing system, an electronic funds deposit request;
accepting, based on the configuration, the electronic funds deposit;
receiving, via a network and from the payment computing system, a payment request associated with an electronic payment transaction received from a vendor transaction computing system;
initiating payment, via the payment token, to a deposit account associated with the electronic payment transaction, based on the payment token configuration; and
sending, via the network and to the payment computing system, confirmation of completion of the electronic payment transaction.

12. The method of claim 11, further comprising:
presenting, at a user device, a payment token configuration screen; and
soliciting, via the payment token configuration screen, a configuration of the payment token.

13. The method of claim 11, further comprising associating a virtual card number to the payment token.

14. The method of claim 13, further comprising identifying, based on the virtual card number, from the electronic payment transaction.

15. The method of claim 11, further comprising:
associating a group of users with permissions to deposit funds to the token account; and
soliciting, via messages sent via the network to each user of the group of users, deposit of funds via one or more electronic transactions.

16. The method of claim 11, further comprising associating a second group of users with permissions to initiate a payment transaction using the token account.

17. The method of claim 11, wherein the payment token configuration comprises one or both of an enablement flag and an association with a payment account.

18. The method of claim 11, wherein the payment account is a credit card, where configuration specifies that the payment token is used for payments when a credit card network is unavailable.

19. The method of claim 11, wherein the payment token is associated with a payment token account.

20. The method of claim 11, wherein the payment token is associated with a payment token account and wherein the payment token account is associated with a plurality of payment tokens, each payment token of the plurality of payment tokens having a different configuration.
